(19) United States
(12) Patent Application Publication
(10) Pub. No.: US 2015/0186488 A1
(43) Pub. Date: Jul. 2, 2015

(54) ASYNCHRONOUS REPLICATION WITH SECURE DATA ERASURE

(71) Applicant: International Business Machines Corporation, Armonk, NY (US)

(72) Inventors: Dietmar Fischer, Woerrstadt (DE); Mukti Jain, Pune (IN); Sandeep R. Patil, Pune (IN); Riyazahamad M. Shiraguppi, Pune (IN)

(73) Assignee: International Business Machines Corporation, Armonk, NY (US)

(21) Appl. No.: 14/141,511

(22) Filed: Dec. 27, 2013

(51) Int. Cl. G06F 17/30; G06F 11/14

(52) U.S. Cl. CPC G06F 17/30578; G06F 17/30371; G06F 11/1471

(57) ABSTRACT

Asynchronous replication of an original data set, at a first location, as a replicated data set, with provision for secure delete operations. A snapshot utility performs a first asynchronous replication operation on an initial version of the original data set to make an initial version of the replicated data set. Some data is subsequently securely deleted from the initial version of the original data set. This secure delete operation is also performed on the initial version of the replicated data set before the next asynchronous replication takes place. In this way, the deletion will be secure (that is, with overwrite) in the replicated data set.

### FIELD OF THE INVENTION

The present invention relates generally to the field of asynchronous replication and more particularly to the snapshot difference file list (SDFL) helping to provide secure deletion of data.

### BACKGROUND OF THE INVENTION

The main difference between synchronous and asynchronous volume replication is that synchronous replication needs to wait for the destination server in any write operation. On the other hand, in asynchronous replication, a write operation is considered complete as soon as a local storage device acknowledges that the write operation was indeed performed. Remote storage is updated, but probably with a small lag. Performance is greatly increased, but in case of losing a local storage, the remote storage is not guaranteed to have the current copy of data and most recent data may be lost. In “semi-synchronous replication” a write operation is considered complete as soon as local storage acknowledges it and a remote server acknowledges that it has received the write either into memory or to a dedicated log file, such that the actual remote write is not performed immediately but is performed asynchronously.

In data storage, dataset replication refers to the process of maintaining two or more identical copies of a dataset, across two or more sites. The replication of data across geographically distributed locations is very common in storage servers. It adds features like failover, failback, disaster recovery, etc., seamlessly to the storage portfolio of large data servers. In replication, the main server site where data is stored is called the “primary server,” and the site where the data is replicated is called the “secondary server” or “standby server.”

In the context of replication, two measures have been defined to measure the effectiveness of a replication deployment. The first measure is defined as the duration of time that elapses between the failure of a primary server and the action of a secondary server taking over control by fail-over. This is called the recovery time objective (RTO). The second measure is defined as the amount of data loss that is permissible during fail-over. The amount of data loss that can be tolerated, measured in units of time preceding a data disaster, is called the recovery point objective (RPO). Data is synced between the primary server and the secondary server. The two basic modes of replication are synchronous and asynchronous.

In synchronous replication, when data is changed at the primary server, the data is replicated at the secondary server, so the replicas are always in sync with each other. The advantage of synchronous replication is that in case of a disaster, data recovery is complete, and there is no data loss. However, this method comes at the cost of increased latency of IO (Input/Output) at the primary server and overall higher network usage.

In asynchronous replication, the data is replicated to the secondary server at regular time intervals (RPO time interval). The write operation to the secondary server is not performed immediately but is performed asynchronously; resulting in better performance than synchronous replication, but with the increased risk of data loss should the primary server go down.

In asynchronous replication, which is based on point-in-time synchronization, periodic snapshots are taken at the primary server and the difference between the two snapshots is sent to the secondary server. A snapshot is a read-only copy, or image, of a file system created at a point in time atomically. The secondary server applies the differences over the previous snapshot to create the next snapshot image. Using this method, replication can occur over smaller, less expensive bandwidth data communication connections such as iSCSI (internet Small Computer System Interface) or T1, instead of fiber optic lines.

Modern file systems generally support a SDFL utility which optimally finds the difference between the two given snapshots and creates a list of modified files and directories, along with the modified data/metadata association.

Snapshots allow a user to create images of specified file systems, and treat them as a file. Snapshot files must be created in the file system upon which the action is performed, and a user may create no more than 20 snapshots per file system.

The SDFL utility plays a major role in asynchronous replication. It optimally finds the difference between the two snapshots and creates a list of modified files and directories. The following are the desired attributes of a SDFL utility: (i) find the exact changes between the snapshots; (ii) mimic the locally applied operations as much as possible; (iii) take advantage of asynchrony in replication (coalesce writes, ignore moot operations such as create/delete); and (iv) satisfy consistency so that the target has the same contents as the source at the end of replay (although write-ordering is not enforced during the replay). The SDFL utility does an inode scan of snapshot S2, to find the changes that happened after snapshot S1.

A data remanence is the residual representation of data that remains even after attempts have been made to remove or erase data. Sophisticated data retrieval techniques can be used on data remanences to recover data even after it is deleted. Hence, enterprise customers prefer to remove data from the storage provider after use or when their subscription is over. The customer needs to ensure that data should be non recoverable by any means, and use the option of a physical secure deletion mechanism.

Secure delete offers an alternative to physical destruction and degaussing, to ensure secure removal of all disk data. Physical destruction and degaussing destroys the digital media, requiring disposal and contributing to electronic waste, which negatively impacts the carbon footprint of individuals and companies.

The basic file deletion command removes direct pointers to data disk sectors and makes data recovery possible with common software tools. Secure delete is a state of the art software mechanism used to counter data remanences on hard disk drives and other digital media. It involves writing patterns of pseudo-random meaningless data multiple times over the media, which makes data retrieval impossible. Secure data erasure software should provide the user with a validation certificate indicating that the overwriting procedure was completed properly. Data erasure software should also comply with requirements to erase hidden areas, provide a defect log list, and list bad sectors that could not be overwritten. The DoD (Department of Defense) and the Center for Magnetic Recording Research (CMRR) define a set of standards for secure deletion of data on hard disk devices.

Partial secure delete operations will now be discussed. At times, users only want secure delete to be applied to certain areas of their files, where sensitive data is stored. In these cases, secure delete is applied only to a specific range in the file. For example, take a theoretical file called “user.db.” The application only wants to delete 0X100 bytes of data, which is present in the file at offset 0x4000 bytes. The secure delete request will only be applied to that particular portion of the file (0x4000, 0x4000+0x100).

### SUMMARY

According to an aspect of the present invention there is a computer program product, system and method for maintaining a replicated data set based on an original data set. The method includes the following steps: (i) performing a first asynchronous replication operation on an initial version of the original data set to make an initial version of the replicated data set that matches the initial version of the original data set; (ii) secure deleting first data from the initial version of the original data set to make a deleted data version of the first data set; (iii) secure deleting the first data from the initial version of the replicated data set to make a deleted data version of the replicated data set; and (iv) performing a second asynchronous replication operation on a post-deletion version of the original data set to make a post-deletion version of the replicated data set that matches the post-deletion version of the original data set.

### BRIEF DESCRIPTION OF THE SEVERAL VIEWS OF THE DRAWINGS

FIG. 1 is a schematic view of a first embodiment of a networked computer system according to the present invention;

FIG. 2 is a flowchart showing a first method according to an embodiment of the present invention;

FIG. 3A is schematic view of a portion of the first embodiment system;

FIG. 3B is a schematic view of another portion of the first embodiment computer system;

FIG. 4 is a flowchart showing a second method according to an embodiment of the present invention; and

FIG. 5 is a flowchart showing a third method according to an embodiment of the present invention.

### DETAILED DESCRIPTION

This Detailed Description section is divided into the following sub-sections: (i) The Hardware and Software Environment; (ii) First Embodiment; (iii) Further Comments and/or Embodiments; and (iv) Definitions.

### I. The Hardware and Software Environment

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java (note: the term(s) “Java” may be subject to trademark rights in various jurisdictions throughout the world and are used here only in reference to the products or services properly denominated by the marks to the extent that such trademark rights may exist), Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

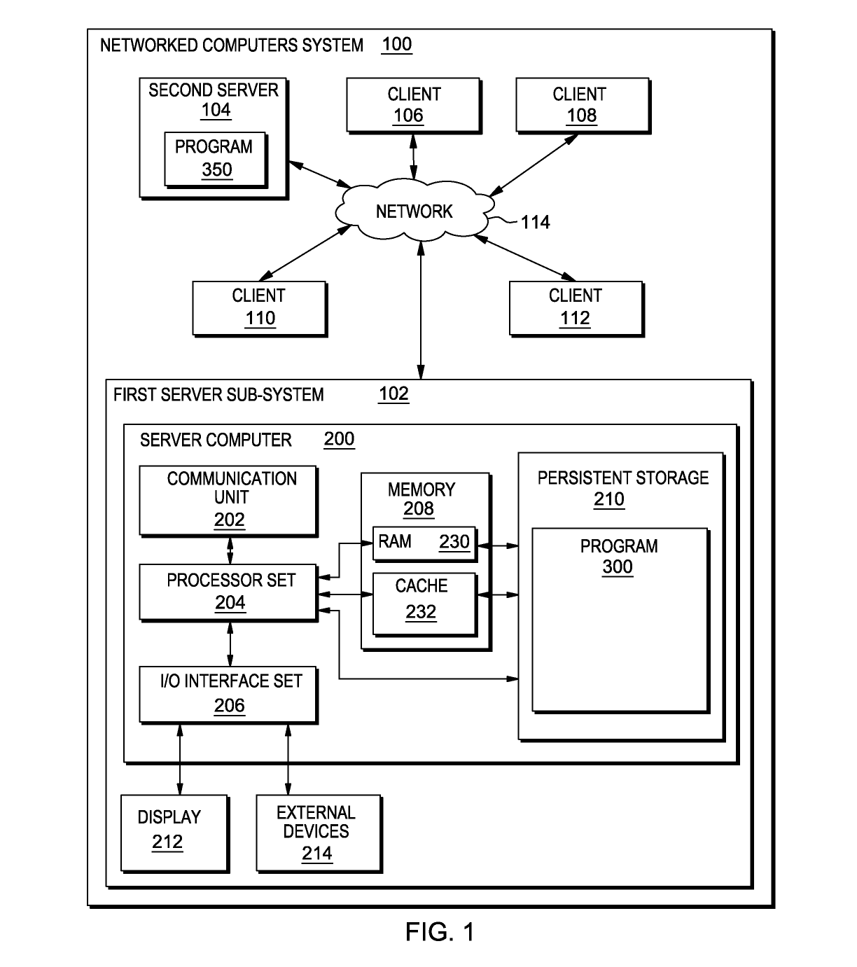

An embodiment of a possible hardware and software environment for software and/or methods according to the present invention will now be described in detail with reference to the Figures. FIG. 1 is functional block diagram illustrating various portions of a networked computers system 100, including: communication network 114; client sub-systems 106, 108, 110, 112; second server computer sub-system 104 (which includes program 350); first server computer sub-system 102. First server computer sub-system 102 includes server computer 200, communication unit 202, processor set 204, input/output (i/o) interface set 206, memory device 208, persistent storage device 210, random access memory (RAM) devices 230, cache memory device 232, program 300, display device 212, and external device set 214.

As shown in FIG. 1, server computer sub-system 102 is, in many respects, representative of the various computer sub-system(s) in the present invention. Accordingly, several portions of computer sub-system 102 will now be discussed in the following paragraphs.

Server computer sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage and control certain software functions that will be discussed in detail, below, in the First Embodiment sub-section of this Detailed Description section.

First server computer sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

It should be appreciated that FIG. 1 provides only an illustration of one implementation (that is, system 100) and does not imply any limitations with regard to the environments in which different embodiments may be implemented. Many modifications to the depicted environment may be made, especially with respect to current and anticipated future advances in cloud computing, distributed computing, smaller computing devices, network communications and the like.

As also shown in FIG. 1, server sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the device on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102, such as client sub-systems 106, 108, 110, 112 and second server 104. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

### II. First Embodiment

Preliminary note: The flowchart and block diagrams in the following Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

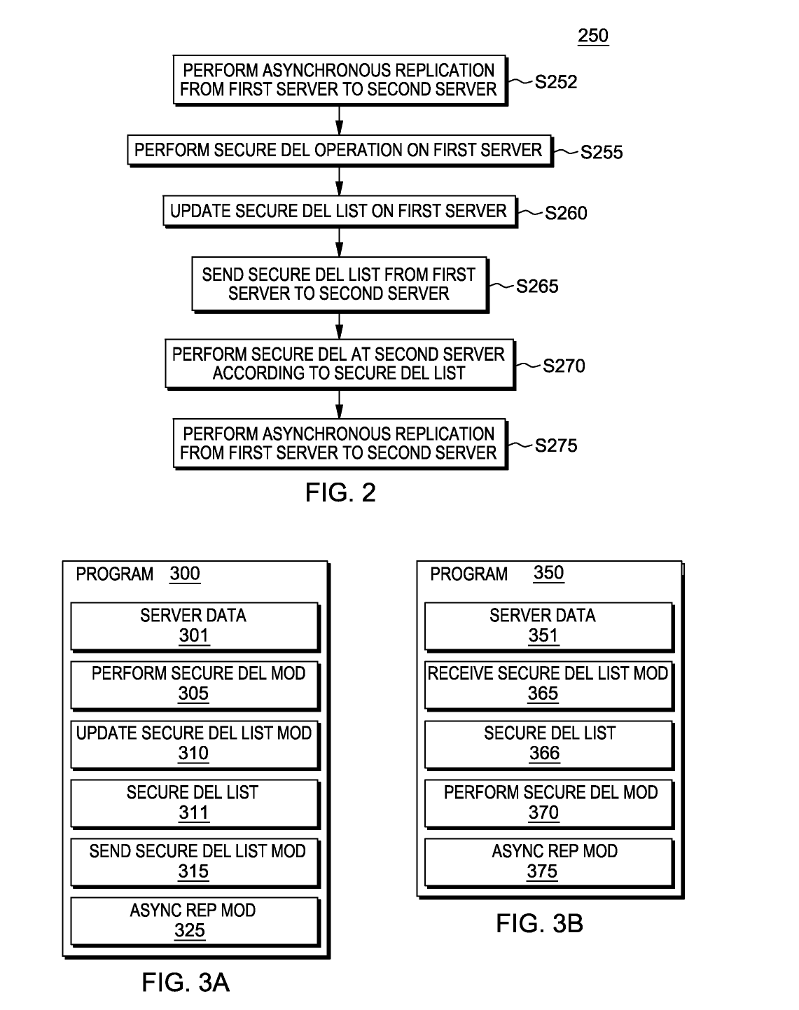

FIG. 2 shows a flow chart 250 depicting a method according to the present invention. FIG. 3A shows program 300 with machine readable instructions for performing at least some of the method steps of flow chart 250. FIG. 3B shows program 350 with machine readable instructions for performing at least some of the method steps of flow chart 250. This method and associated software will now be discussed, over the course of the following paragraphs, with extensive reference to FIG. 2 (for the method step blocks) and FIGS. 3A and 3B (for the software blocks).

Processing begins at step S252 where server data set 301 (stored in program 300 of first server computer sub-system 102 (see FIG. 1) is asynchronously replicated to server data set 351 (stored in program 350 of second server computer sub-system 104 (see FIG. 1) by the following modules (“mods”) working co-operatively over network 114: (i) asynchronous replication mod 325 (see FIG. 3A); and (ii) asynchronous replication mod 375 (see FIG. 3B). In this embodiment, this replication is done by comparison of snapshots, as will be discussed in more detail, below, in the Further Comments And/Or Embodiments sub-section of this Detailed Description section. Alternatively, the asynchronous replication operation may be any type of asynchronous replication operation currently conventional or to be developed in the future.

Processing proceeds to step S255, where perform secure delete mod 305 (see FIG. 3A) of program 300 performs the secure delete operation on server data set 301 of the first (also called “primary”) server computer sub-system 102. The secure delete operation may be according to any secure delete algorithm now known or to be developed in the future. Alternatively, the delete operation may be any sort of delete operation that may result in remanence. It is noted that in between step S252 and step S255, server data set 301 will generally change in various ways as users work with this data set. For example, data may be added to data set 301. This is common for replicated data sets, and it is the main reason that data sets must be repeatedly replicated in asynchronous replication schemes, such as the one currently under discussion. It is not necessary for purposes of the present invention that data be added to, or revised in, data set 301 in the time between the performance of steps S252 and S255, but such additions and/or revisions will often be the “norm.”

Processing proceeds to step S260, where update secure delete list mod 310 (see FIG. 3A) updates a secure delete list 311 on the first (primary) server computer sub-system 102, to reflect the secure delete operation previously performed at step S255. An example of a secure delete list will be set forth, below, in the Further Comments And/Or Embodiments sub-section of this Detailed Description section. Processing proceeds to step S265, where: (i) send secure delete list mod 315 (see FIG. 3A) sends a communication with the data of secure delete list 311 from the first (primary) server computer sub-system 102 over network 114 (see FIG. 1); and (ii) the communication is received by receive secure delete list mod 365 of program 350 of second (or secondary) server computer sub-system 104 (see FIG. 1). Mod 365 stores the secure delete list data as secure delete list 366 of program 350.

Processing proceeds to step S270, where the secure delete operation is performed on server data set 351 (see FIG. 3B) on the secondary server under control of secure delete mod 370. By performing the secure delete before the next successive asynchronous replication operation is performed, this prevents remanence in secondary server data set 351 when the next successive asynchronous replication operation is performed.

Some possible variations on the timing of steps S265 and S270 will now be discussed. In one variation, steps S265 and S270 are performed immediately after step S260 (that is, the secure delete on the primary) is performed. In another variation, steps S265 and S270 are performed well after step S260, and only performed immediately before the completion the next successive asynchronous replication operation (that is, step S275 to be discussed below). In yet another variation, steps S260 and S275 are performed at some intermediate time in between step S260 and the next successive asynchronous replication operation. In yet another variation, step S270 is to be performed even after the next successive asynchronous replication of step S275.

Processing proceeds to step S275, where mod 325 performs asynchronous replication between the first (primary) server mod and the second (secondary) server mod 375. It is noted that in between step S260 and step S275, server data set 301 will generally change in various ways as users work with this data set (after the secure delete operation, but before the next successive asynchronous replication). For example, data may be added to data set 301. As mentioned above, this is common for replicated data sets, and it is the main reason that data sets must be repeatedly replicated in asynchronous replication schemes, such as the one currently under discussion. Again, it is not necessary for purposes of the present invention that data be added to, or revised in, data set 301 in the time between the performance of steps S252 and S255, but such additions and/or revisions will often be the “norm.”

In this embodiment of method 250, there is only one secure delete operation between two successive asynchronous replication operations, but it should be understood that there may be multiple secure delete operations between two successive asynchronous replication operations. It is possible to have multiple secure delete operations between successive asynchronous replications.

### III. Further Comments and/or Embodiments

As those of ordinary skill in the art can appreciate, it is helpful to know what data has been securely deleted, even if it is already known what data was deleted in a non-secure-delete manner. Some embodiments of the present disclosure consider information about secure delete of data that has not conventionally been considered.

When data is asynchronously replicated from the primary server to the secondary server, the replication process will not be aware of certain secure deletion of data operations. Likewise, the SDFL (snapshot difference file list) utility can not be used to determine these certain secure deletion of data operations. Specifically, a secure deletion of data will not be determinable from snapshots when: (i) the data is written after a first snapshot has taken; and (ii) securely deleted before a second snapshot (the next consecutive snapshot after the first snapshot) has been taken. Currently, asynchronous replication techniques only look at data/metadata changes that can be determined by comparing successive snapshots (with the snapshots corresponding to synchronization points between the primary server and secondary server). Because this replication process only looks at the changes between the new and old files, secure deletion of previous data can be missed.

The process of secure deletion can be performed on data files in two ways. The first way is secure deletion of a partial file. When only a portion of a data file is securely deleted at the primary server, and updated with new content, replication techniques will only consider the changes between the contents as shown by comparison of the new and old snapshots. Thus, the secure delete operation that was performed on the original file data (relating to data both added and then deleted between the time of the new and old snapshots) will not be performed on the secondary server. Due to data remanence, this sensitive data can be recovered and could pose a serious security risk. The second way that secure deletion can be performed is secure deletion of the whole file or file rename. As those of skill in the art will appreciate, data remanence means even when we have written new data, the old data can be recovered. For example in the previous case if secure delete won't be done on the secondary side, and the new data is just overwritten on the old data, the old data can still be recovered.

With synchronous replication, secure delete operations can be easily replicated to the secondary server because all data writing and subsequent data deleting operations will be performed on both the primary and secondary servers, substantially at the same time and on an ongoing basis. However, with asynchronous replication, replication is done at a later point in time, where the secure delete file information is lost at the primary server. In this way, the replication is not compliant with the secure delete semantics. The confidential data which is not secure deleted at the secondary server, can pose a serious security risk, as the data is easily recoverable. In this case, where two data center sites are communicating with each other, the secure delete operation needs to performed when both sites are connected and after any reconnection.

Some embodiments of the present disclosure notify the SDFL utility of deletions of data (especially secure deletions of data): (i) during asynchronous replication; and/or (ii) in the time intervals between successive asynchronous replication operations (for example, embodiments were data deletions at the primary server cause the secondary server to write any as-yet unwritten data involved in the deletion and then delete the data in a synchronous manner, while still allowing the bulk of replication to occur asynchronously on a snapshot basis). In some embodiments: (i) the primary server will maintain the secure delete information in the form of lists of files along with data chunks, where secure delete operations at the desired security level, are performed; and (ii) the SDFL utility will transfer this information to the secondary server and the secondary server will perform the secure delete operation based on that information.

Some embodiments of the present invention may include one, or more, of the following features, characteristics and/or advantages: (i) for each snapshot, the primary server will keep the list of files on which the partial or complete secure delete is done; (ii) for each of these files, the implementation process keeps track of which secure delete algorithm file system was used to secure delete the data, and the range of blocks which was securely deleted; (iii) this list of files and their secure delete information can be stored as either part of the file system metadata or as a separate system file; (iv) the existing SDFL utility will be modified to transfer the secure delete information to the secondary server before starting the normal replication of a snapshot; (v) after the replication, the SDFL utility can delete this file from the primary server; (vi) the secondary server references this information to do secure delete of these files; (vii) the secondary server gets the list of files, and performs secure delete with the respective algorithms of the desired blocks; (viii) the secondary server can either do the secure delete of the blocks inline, or in the background with the replication; and/or (ix) existing tools can be used to do the secure delete in the background.

Two steps of a method (“Step 1” and Step 2”) according to the present disclosure will now be discussed in the following paragraphs.

Step 1: The secure data erasure information is maintained at the primary server until the corresponding delete is done at the secondary server. Whenever the primary server gets a secure delete request for any file, it stores: (i) the data block range of the file it “secure deleted” (this is stored in a secure delete list); and (ii) the algorithm it used to “secure delete” the information (this is stored in a secure delete algorithms table). The following Table 1 is an example of a secure delete algorithms table.

| Algorithm Id | Algorithm |
|---|---|
| 1 | Gutmann Method |
| 2 | DoD 5220.22-M (E) - NISPOM |
| 3 | BSI IT Baseline Protection Manual |
| 4 | Value pattern, complement, value - NISPOM |
| 5 | Overwrite with zeroes |

The following Table 2 is an example of a secure delete list:

| Snapshot | | Sec del | |
|---|---|---|---|
| ID | File Path | alg id | List of block range |
| 3 | a/b/c/sample.txt | 5 | <100, 200>, <400, 500> |
| 4 | b/c/d/sample.xls | 2 | <0, 20000> |
| 4 | a/e/sample.db | 1 | <1000, 2000>, <4000, 5000> |

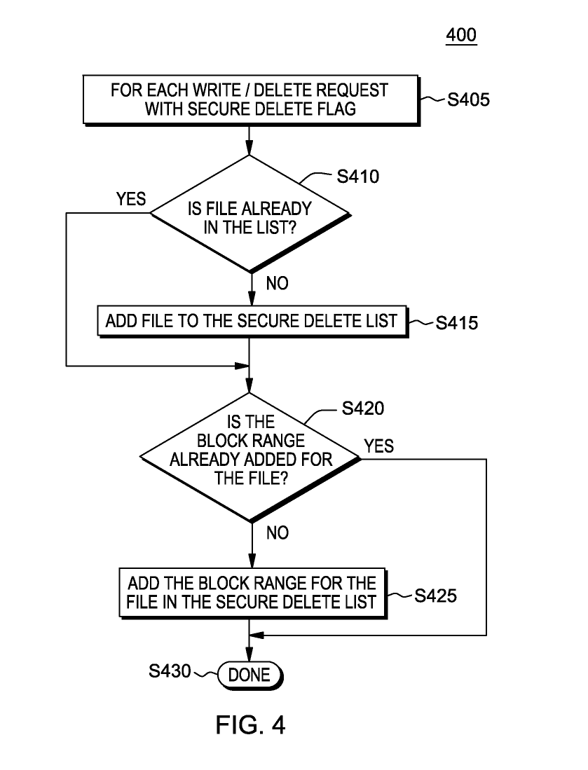

As shown in FIG. 4, flowchart 400 shows a method of creating a secure delete list. Processing begins at step S405, where a secure delete flag is established for each write/delete request. Processing proceeds to step S410, where a decision is made as to whether or not the file is on the secure delete list. If the file is not on the secure delete list (No), processing continues to step S415 which adds the file to the secure delete list. If the file is on the secure delete list (Yes), processing proceeds to step S420, where a decision is made as to whether or not the data block range has already been added to the file. If the block range has been added to the file (Yes), processing continues to step S430, where the processing concludes (Done). If the block range has not been added to the file (No), processing continues to step S425 where the block range for the file is added to the secure delete list. Processing proceeds to step S430, where processing concludes (Done).

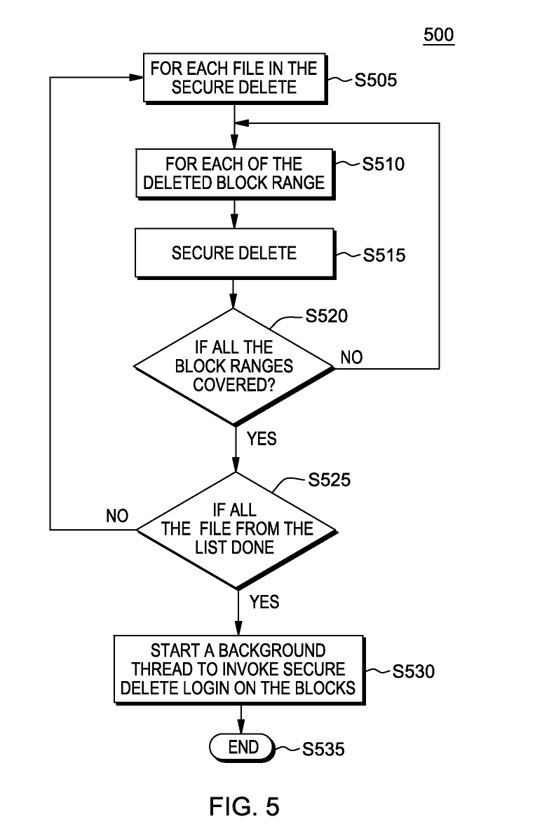

Step 2: Secure erasure is replicated on the secondary server, as shown in flowchart 500 of FIG. 5. At the start of replication, the secure delete of files at the secondary server can be done in the following sub-steps: (i) the secondary server gets the list of secure deleted files with the block ranges (see steps S505, S510, S515, S520 and S525); and (ii) for each file in the list and for each block range, invoke the respective secure delete algorithm to secure delete the blocks (see steps S530 and S535). At secure delete step S515, to perform secure delete in the background, the software: (i) moves the current blocks to a temporary location; (ii) allocates “new data chunks” as replacements (which should have already been securely deleted); (iii) performs secure delete functions to the old locations in the background; and (iv) continues with the rest of the snapshot utilities process.

Some embodiments of the present disclosure may include one, or more, of the following features, characteristics and/or advantages: (i) secure delete semantics can be maintained in a replication environment where confidential user data, securely deleted at the primary server, needs to be securely deleted from the secondary server; (ii) a snapshot utility is notified of the secure delete of data during asynchronous replication to increase the security of data residing on the cloud; (iii) a snapshot utility is notified of the secure delete of data during asynchronous replication to increase the customer's data privacy on the cloud (this is often lacking in conventional systems); (iv) an asynchronous replication environment that performs the secure delete as well as performing a transfer to the remote or secondary server; (v) support for write coalescing where write operations are combined to transfer final write to the secondary server; (vi) the secure delete operation is considered as a special case where secure delete block information is transferred separately to the secondary server (this mechanism does not require any separate disaster proof storage or maintaining logs and has performance benefits and reduced latencies due to write coalescing); and/or (v) secure delete block information is transferred separately to a secondary server at the same time, thereby ensuring semantics of secure delete. Ensuring semantics means if the data is securely deleted at the primary site, it should be securely deleted at the secondary site too, to maintain the semantics of secure delete in asynchronous replication.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Software storage device: any device (or set of devices) capable of storing computer code in a manner less transient than a signal in transit.

Tangible medium software storage device: any software storage device (see Definition, above) that stores the computer code in and/or on a tangible medium.

Computer: any device with significant data processing and/or machine readable instruction reading capabilities including, but not limited to: desktop computers, mainframe computers, laptop computers, field-programmable gate array (fpga) based devices, smart phones, personal digital assistants (PDAs), body-mounted or inserted computers, embedded device style computers, application-specific integrated circuit (ASIC) based devices.

Asynchronous: includes semi-synchronous systems.

Pure-asynchronous: does not include semi-synchronous systems.

Secure deleting/secure deleted: performing a “secure delete.”

What is claimed is:

1. A method for maintaining a replicated data set based on an original data set, the method comprising:
performing a first asynchronous replication operation on an initial version of the original data set to make an initial version of the replicated data set that matches the initial version of the original data set;
secure deleting first data from the initial version of the original data set to make a deleted data version of the first data set;
secure deleting the first data from the initial version of the replicated data set to make a deleted data version of the replicated data set; and
performing a second asynchronous replication operation on a post-deletion version of the original data set to make a post-deletion version of the replicated data set that matches the post-deletion version of the original data set.

2. The method of claim 1 wherein:
the performance of the first asynchronous replication operation is performed by a snapshot utility that compares snapshots of the initial versions of the original and replicated data sets;
the performance of the second asynchronous replication operation is performed by the snapshot utility that compares snapshots of the post-deletion versions of the original and replicated data sets; and
the secure deletion of the first data from the original version replicated data set is based upon a secure delete block list which identifies the first data and which is received from the snapshot utility.

3. The method of claim 2 wherein:
the initial and post-deletion versions of the original data set are stored on a primary server computer;
the initial and post-deletion versions of the replicated data set are stored on a secondary server computer; and
the primary and secondary computers are connected in data communication over a communication network.

4. The method of claim 3 wherein:
the secure deletion of the deleted data from the original data set writes patterns of pseudo-random meaningless data multiple times over the data being deleted; and
the deletion of the deleted data from the replicated data set writes patterns of pseudo-random meaningless data multiple times over the data being deleted.

5. The method of claim 1 further comprising:
prior to the performance of the second asynchronous replication operation, sending a secure delete block list identifying the first data, from the primary server computer to the secondary server computer.

6. The method of claim 5 wherein the secure delete block list includes, for each secure deletion operation: a file path, an algorithm and a block range.

7. A computer program product for maintaining a replicated data set based on an original data set, the computer program product comprising software stored on a software storage device, the software comprising:
first program instructions programmed to perform a first asynchronous replication operation on an initial version of the original data set to make an initial version of the replicated data set that matches the initial version of the original data set;
second program instructions programmed to secure delete first data from the initial version of the original data set to make a deleted data version of the first data set;
third program instructions programmed to secure delete the first data from the initial version of the replicated data set to make a deleted data version of the replicated data set; and
fourth program instructions programmed to perform a second asynchronous replication operation on a post-deletion version of the original data set to make a post-deletion version of the replicated data set that matches the post-deletion version of the original data set;
wherein:
the software is stored on a software storage device in a manner less transitory than a signal in transit.

8. The product of claim 7 wherein:
the first program instructions use a snapshot utility that compares snapshots of the initial versions of the original and replicated data sets;
the fourth program instructions use the snapshot utility that compares snapshots of the post-deletion versions of the original and replicated data sets; and
the third program instructions secure delete the first data from the original version of the replicated data set is based upon a secure delete block list which identifies the first data and which is received from the snapshot utility.

9. The product of claim 8 wherein:
the initial and post-deletion versions of the original data set are stored on a primary server computer;
the initial and post-deletion versions of the replicated data set are stored on a secondary server computer; and
the primary and secondary computers are connected in data communication over a communication network.

10. The product of claim 9 wherein:
the second program instructions write patterns of pseudo-random meaningless data multiple times over the data being deleted; and
the third program instructions write patterns of pseudo-random meaningless data multiple times over the data being deleted.

11. The product of claim 7 further comprising:
fifth program instructions programmed to, prior to the performance of the second asynchronous replication operation, send a secure delete block list identifying the first data, from the primary server computer to the secondary server computer.

12. The product of claim 11 wherein the secure delete block list includes, for each secure deletion operation: a file path, an algorithm and a block range.

13. A computer system for maintaining a replicated data set based on an original data set, the computer system comprising:
a processor(s) set; and
a software storage device;
wherein:
the processor set is structured, located, connected and/or programmed to run software stored on the software storage device; and
the software comprises:
first program instructions programmed to perform a first asynchronous replication operation on an initial version of the original data set to make an initial version of the replicated data set that matches the initial version of the original data set;
second program instructions programmed to secure delete first data from the initial version of the original data set to make a deleted data version of the first data set;
third program instructions programmed to secure delete the first data from the initial version of the replicated data set to make a deleted data version of the replicated data set; and
fourth program instructions programmed to perform a second asynchronous replication operation on a post-deletion version of the original data set to make a post-deletion version of the replicated data set that matches the post-deletion version of the original data set.

14. The system of claim 13 wherein:
the first program instructions use a snapshot utility that compares snapshots of the initial versions of the original and replicated data sets;
the fourth program instructions use the snapshot utility that compares snapshots of the post-deletion versions of the original and replicated data sets; and
the third program instructions secure delete the first data from the original version of the replicated data set is based upon a secure delete block list which identifies the first data and which is received from the snapshot utility.

15. The system of claim 14 wherein:
the initial and post-deletion versions of the original data set are stored on a primary server computer;
the initial and post-deletion versions of the replicated data set are stored on a secondary server computer; and
the primary and secondary computers are connected in data communication over a communication network.

16. The system of claim 13 wherein:
the second program instructions write patterns of pseudo-random meaningless data multiple times over the data being deleted; and
the third program instructions write patterns of pseudo-random meaningless data multiple times over the data being deleted.

17. The system of claim 16 further comprising:
fifth program instructions programmed to, prior to the performance of the second asynchronous replication operation, send a secure delete block list identifying the first data, from the primary server computer to the secondary server computer.

18. The system of claim 17 wherein the secure delete block list includes, for each secure deletion operation: a file path, an algorithm and a block range.
